(19) United States
(12) Patent Application Publication
(10) Pub. No.: US 2025/0093666 A1
(43) Pub. Date: Mar. 20, 2025

(54) ELECTRONIC CONNECTOR

(71) Applicant: Apple Inc., Cupertino, CA (US)

(72) Inventors: Josiah C. Frye, Bothell, WA (US); Ibuki Kamei, Santa Clara, CA (US); John Raff, Menlo Park, CA (US); Varun K. Sanghvi, San Francisco, CA (US)

(21) Appl. No.: 18/818,128

(22) Filed: Aug. 28, 2024

Related U.S. Application Data
(60) Provisional application No. 63/583,944, filed on Sep. 20, 2023.
(60) Provisional application No. 63/608,602, filed on Dec. 11, 2023.

(51) Int. Cl. G02B 27/01; G02C 11/00; H01R 13/22; H01R 13/62; H01R 13/627

(52) U.S. Cl. CPC G02B 27/0176; G02C 11/10; H01R 13/6205; H01R 13/627; G02B 2027/0178; H01R 13/22

(57) ABSTRACT

A head-mountable device can include a frame, a window secured to the frame, and a securement arm extending from the frame. The securement arm can include a proximal end a distal tip opposite the proximal end. The securement arm can further include a waveguide, which can be configured to direct light at the window, and an electronic port disposed at the distal tip and electrically coupled to the waveguide. The securement arm can also include a housing that can include a proximal portion and a distal portion disposed at an angle to define an aperture. A battery, as well as a port, can be disposed in the housing, wherein the port can include the aperture and a contact electrically coupled to the battery. The contact, along with a retention feature, can further define the aperture. The securement arm can include an electronic port disposed at the distal tip, wherein the electronic port can be a selectively translatable electrical contact. The selectively translatable electrical contact can be an open configuration where the electrical contact can be exposed to an external environment and a closed configuration where the electrical contact can be inaccessible and disposed within the distal tip.

### CROSS-REFERENCE TO RELATED APPLICATION

This application claims the benefit of U.S. Provisional Patent Application No. 63/583,944, filed 20 Sep. 2023, and entitled “ELECTRONIC CONNECTOR,” and also claims the benefit of U.S. Provisional Patent Application No. 63/608,602, filed 11 Dec. 2023 and entitled “ELECTRONIC CONNECTOR,” the entire disclosures of which are hereby incorporated by reference.

### FIELD

The examples of the present disclosure relate generally to electronic devices. More particularly, the examples of the present disclosure relate to head-mountable electronic devices.

### BACKGROUND

Various components of head-mountable electronic devices, such as display screens, viewing frames, securement arms, speakers, batteries, waveguides, and other components, operate together to provide an immersive and comfortable experience. Operation of these devices can require a connector for an external attachment. This attachment can be used for various purposes, such as for charging the device and any other purpose for the benefit of the user. The attachment can also be configured to be used while a user is operating the head-mountable device. However, the anatomy of each user's head is unique. One user's ears can be a different size than another. The distance between the front of a user's head and their ear, as well as the distance between a user's ear and the back of their head can vary. Other anatomical features, including relative positions of a user's nose, forehead, eyes, as well as features such as hair length, can also vary between users. The anatomical variety of different users presents a challenge for connectors to external attachments for head-mountable devices designed for comfort and reliability.

Additionally, head-mountable devices can be used in a variety of different settings and during a variety of different activities. These can range from lying down still in bed to mountain biking or hiking outdoors. Thus, even for a single user, the connection for an external attachment of a head-mountable device that is secure for one activity may not be secure for another activity.

### SUMMARY

Various examples of the present disclosure include a device including a frame, a window secured to the frame, and a securement arm. The securement arm of the device can include a proximal end secured to the frame, and a distal tip opposite the proximal end. A waveguide can be disposed in the securement arm and configured to direct light displayed at the window. Furthermore, an electronic port can be disposed at the distal tip and can also be electrically coupled to the waveguide.

In one example, the distal tip of the device can be configured to be disposed behind a user's ear when the user dons the device. In another example, the securement arm of the device can include a first joint between the proximal end and the frame and a second joint can be disposed between the proximal end and the distal tip.

In various examples of the present disclosure, the port can be disposed distal to the second joint, which can be an area comfortable for the user. Furthermore, the waveguide can be disposed between the first joint and the second joint. In one example, the port can include an aperture that can be defined by the distal tip of the securement arm. The distal tip can include an inner surface, which can define the aperture, wherein first and second electrical contacts can further define the inner surface.

In at least one example, a battery can be disposed in the distal tip, which, in some examples, can electrically couple the first and second electrical contacts to the waveguide. The electronic port can include a first electrical contact defining an external surface of the securement arm. The electronic port can also include a second electrical contact defining the external surface.

In some examples of the present disclosure, an electronic securement arm for a wearable device can include a housing, wherein the housing can include a proximal portion and a distal portion. In at least one example, the distal portion can be disposed at an angle relative to the proximal portion, where the distal portion can define an aperture. A battery, as well as a port, can also be disposed in the housing. Furthermore, the port can include the aperture and a contact electrically coupled to the battery, where in at least one example the contact can define the aperture. In some examples, a retention feature can also define the aperture, where the retention feature can enable the user to perform a variety of activities while donning the device connected to an external attachment.

In various examples of the present disclosure, the aperture of the electronic securement arm can be defined by a through-hole extending entirely through the distal portion. In some examples, the port can include a data entry port, and in some examples, the port can include a power port. In at least one example, the distal portion can include an inner surface defining the aperture. The inner surface can also define a detent, wherein the retention feature can also include the detent. In some examples, a first electrical contact and a second electrical contact can define the inner surface of the distal portion.

In some examples of the present disclosure, a smart glasses arm can further include a distal tip, an electronic component disposed in the distal tip, and an electronic port disposed at the distal tip. In one or more examples, the electronic port can include a selectively translatable electrical contact, wherein the selectively translatable electrical contact can include an open configuration including the electrical contact exposed to an external environment and a closed configuration including the electrical contact being inaccessible and disposed within the distal tip.

In at least one example, the electronic port can include a first portion having a first diameter, and a second portion having a second diameter less than the first diameter. The first portion can define an external surface of the distal tip in the closed configuration. In at least one example, the second portion can also include the electrical contact.

In at least one example of the present disclosure, the electronic port of the smart glasses arm can be configured to be manually operable between the open configuration and the closed configuration. In one example, the electronic port can include a magnet. In one example, the electronic port can also be magnetically operable between the open configuration and the closed configuration. In at least one example, a ferrous component can also be disposed in the distal tip, which can bias the electronic port in the closed configuration via the magnet.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top-down view of an example of an electronic connector;

FIG. 2A illustrates a side-view of an example of an electronic connector;

FIG. 2B illustrates another side-view of an example of an electronic connector in relation to the head of a user;

FIG. 3 illustrates a sequence of connections and components within the electronic connector;

FIG. 4 illustrates a side-view thereof, illustrating an example of an electronic port, according to the present disclosure;

FIG. 5 illustrates a perspective-view of an example of a port attachment, according to the present disclosure;

FIG. 6A illustrates a cross-sectional side-view of an example of a selective port in a closed position;

FIG. 6B illustrates a cross-sectional side-view of an example of a selective port in an open position;

FIG. 6C illustrates a side-view of an example of a selective port in an open position;

FIG. 7 illustrates a perspective view of an example of a port attachment, according to the present disclosure;

FIG. 8 illustrates a side-view of an example of a port attachment, according to the present disclosure;

FIG. 9 illustrates a cross-sectional side-view example of the union of an electronic port and attachment, according the present disclosure;

FIG. 10 illustrates a cross-sectional side-view example of the union of an electronic port and attachment, according to the present disclosure;

FIG. 11A illustrates a cross-sectional side-view example of another electronic port and attachment, according to the present disclosure; and

FIG. 11B illustrates another side-view and top view of the electronic port attachment of FIG. 11A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure generally relates to electronic devices. More particularly, the present disclosure relates to head-mountable electronic devices. In at least one example, a head-mountable electronic device can include a frame and a securement arm extending from the frame. The securement arm can include a power port and/or data port positioned at a distal end or tip of the securement arm behind a user's ear during use. Examples of head-mountable devices can include optical devices (e.g., glasses, transparent windows, etc.) or virtual/augmented reality devices that can include an optical component. In these cases, the head-mountable device can be worn on the head of a user such that optically transparent widows, for example lenses and transparent optical displays, can be positioned in front of a user's eyes. Other electrical components for the powering and operation of the device can also be disposed in the device, for example batteries and waveguides. The electronic port disposed distally on the securement arm can be electrically coupled to the various other electronic components of the device to provide a connection point for data or power cables.

Current wearable devices can include port connections at locations designed for use when the user is not wearing the device and/or where data or power cables interfere with the experience of the user and create discomfort during use. The securement arms of a head-mountable device described herein are designed for comfort and securement during long-term use. Any electrical component, including electrical ports and other components mentioned herein, which may be placed in or on the securement arm itself, can be designed and placed strategically to avoid interfering with the weight distribution, securement forces, comfort, and/or field of view of the device and the user, enabling in-use data and power connections.

As noted above, in a particular example, the electronic port is disposed at the distal tip of the securement arm, wherein the electronic port can be electrically coupled to the electronic components disposed in the device. In some examples, the distal tip of the securement arm can be disposed behind a user's ear when the user dons the head-mountable device. This can enable the user to comfortably connect external attachments to the electronic port while operating the device.

In at least one example, connecting an external attachment through the electronic port can assist with charging and/or data entry during operation of the device. This can enable the user to operate the device for an extended period of time, among other advantages.

In some examples, the distal tip of the securement arm can be defined by an aperture, wherein the electronic port can include electrical contacts that define the inner surface of the aperture. In a particular example, the aperture can be a through-hole extending entirely through the distal portion. In this example, the aperture and an external attachment can be configured with retention detents that can hold the attachment in place while the user operates the device. This can enable the user to perform various activities while operating the head-mountable electronic device.

In a particular example, the electronic port can include a selectively translatable electrical contact that can be manually or magnetically configured into closed and open positions. The open position can include the electrical contacts of the electronic port being exposed to an external environment. The closed position can include the electrical contacts being inaccessible and disposed within the distal tip of the device, and the first portion can lie flush with the surface of the securement arm. This configuration can enable the device to prevent unwanted materials from interfering with the electrical contacts, such as the user's hair, clothing, moisture, and so forth.

The physical design and distal position of the electronic port on the securement arm of a head-mountable device allows a user to connect to data and power sources while using the device while enhancing comfort and minimizing interference from the cables or connection. Accordingly, the examples of electronic ports and connectors in the present disclosure can provide the user with secure and comfortable methods of connecting external attachments to head-mountable devices.

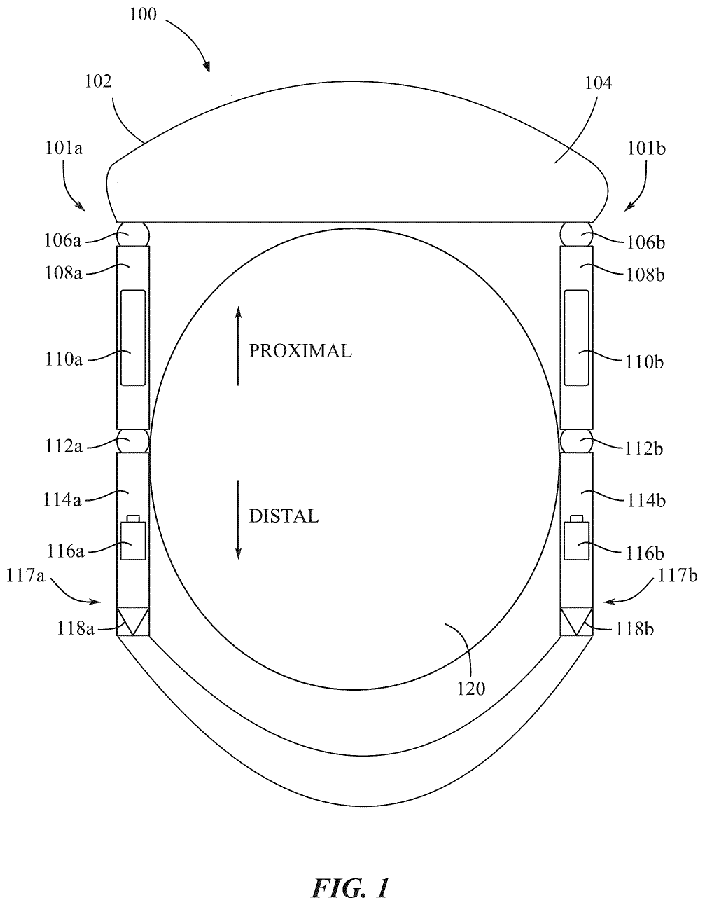

These and other embodiments are discussed below with reference to FIGS. 1-11B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top-down view of an example of a head-mountable electronic device 100. The head-mountable electronic device 100 can be any device or system configured to be worn on the head 120 of the user, such as a head-mountable electronic device, an optical device, smart glasses, alternate/virtual reality goggles, and the like. As shown in FIG. 1, the device 100 can include a viewing frame 102, which can house a variety of components and systems. In at least one example, the viewing frame 102 can be configured to secure one or more optically transparent windows 104, for example transparent material, optical lenses, or transparent display screens, in front of the eyes of the user. According to the example shown in FIG. 1, at least one of the securement arms 101a and 101b can be attached to the viewing frame 102. Securement arms 101a and 101b can include proximal ends 108a and 108b, which can be attached to the viewing frame 102, with distal ends 114a and 114b further extending from the proximal ends 108a and 108b, respectively.

In at least one example, the securement arms 101a and 101b can include a first joint 106a, 106b. The first joints 106a and 106b can be placed between the proximal ends 108a, 108b of the securement arms 101a, 101b and the viewing frame 102. According to the example of FIG. 1, the securement arms 101a and 101b can also include second joints 112a and 112b, which can be located between the proximal ends 108a, 108b, and the distal ends 114a, 114b of the securement arms 101a, 101b. The combination of the first and second joints 106a, 106b, 112a, and 112b can be advantageous to the user in that the device 100 can better conform to a wide variety of user head and face sizes and shapes. Better conformity to different sizes and shapes can result in greater comfort felt by a wide range of users wearing the device 100, as well as enabling sufficient retention when the user moved while donning the device 100.

FIG. 1 also illustrates the use of other components that can be housed inside the securement arms 101a and 101b. In at least one example, the securement arms 101a and 101b can house a variety of different components including, but not limited to, electronic components 110a, 110b. The electronic components 101a-b can include one or more projectors, waveguides, processors, speakers, and so forth. Other electronic components can be included with the securement arms 101a-b, including batteries 116a and 116b and electronic ports 118a and 118b. In examples where the electronic components 110a-b include one or more projectors and/or waveguides housed in at least one of the securement arms 101a and 101b, the projectors and waveguides can be configured to direct light displayed at the window 104 attached to the viewing frame 102.

In at least one example, a battery 116a, 116b can also be housed in at least one of the securement arms 101a and 101b. The use of batteries 116a and 116b can be advantageous to the user of the device 100 in that it can extend usage time. Batteries 116a and 116b can allow the user to operate the device 100 without having to frequently interrupt operation to charge device 100, therefore increasing productivity and efficiency of use for the user.

In at least one example, electronic ports 118a and 118b can be disposed on or in at least one of the securement arms 101a and 101b. In some examples, the electronic ports 118a and 118b can be disposed at the distal tips 117a and 117b of the distal ends 114a and 114b of the securement arms 101a and 101b. The distal tips 117a and 117b can be defined as a portion or section of the securement arm 110a-b configured to be disposed behind the car of the user when the device 100 is donned. In some examples, depending on the dimensions of the user's face and head, the distal tips 117a-b include about 30% or less of a total longitudinal length of the securement arms 110a-b between the proximal end of the securement arms 101a-b to a distal end of the securement arms 101a-b. In one example, the distal tips 117a, 117b, can include about 20% or less of the total longitudinal length of the securement arm 101a-b, or about 10% of the longitudinal length of the securement arms 101a-b. The electronic ports 118a and 118b can enable the user to easily access to charging capabilities while operating the head-mounted electronic device.

Any of the features, components, and/or parts, of the rim 360 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

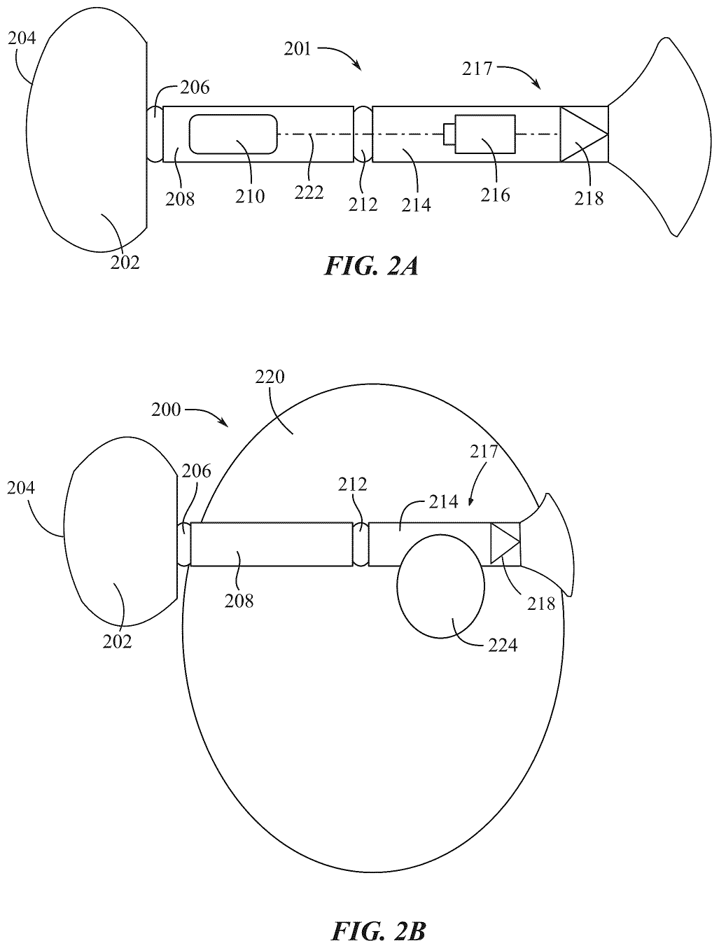

FIGS. 2A and 2B show a side view of an example of a head-mountable electronic device 200. In at least one example, one or more optically transparent windows 204 can be secured to the viewing frame 202 of the device 200. A securement arm 201 can also be attached to the viewing frame 202. As shown in FIG. 2A, a securement arm 201 can be separated into different sections. For example, the securement arm 201 can include a proximal section or portion 208 and a distal section or portion 214, where the proximal portion 208 can be attached to the viewing frame 202 by means of a first joint 206. In at least one example, a second joint 212 can join the proximal portion 208 with the distal portion 214. In some examples, the combination of the first joint 206, the proximal portion 208, the second joint 212, and the distal portion 218 can form a single structure for a securement arm 201 of the device 100.

In at least one example, the securement arm 201 can house a variety of different electronic components 210, including but not limited to one or more waveguides and/or projectors. One or more other electronic components, including a battery 216 and an electronic port 218. According to the example of FIG. 2A, the electronic component 210 can be disposed between the first and second joints 206 and 212. Disposing the electronic component 210 in the proximal end 208 of the securement arm 201 can be advantageous in that the proximal end 208 of the securement arm 201 is closer in proximity to the at least one optically transparent window 204. In examples where the electronic component includes one or more projectors or waveguides, the proximal location thereof can enable the projectors and/or waveguides to efficiently direct light to the desired target and enhance the operation of the device 100 for the user.

In at least one example, a battery 216 can be disposed with the distal portion 214. The placement of the battery 216 in the distal portion 214 can allow ample space for the waveguide 210 in other parts of the securement arm 201, such as within the proximal portion 208. In addition, the distal portion 214 can include a distal tip 217 of the securement arm 201. In one example, the distal tip 217 includes 30% or less of a total length of the securement arm 201 at the distal end thereof such that the distal tip 217 is disposed behind the user's ear when donned. In some examples, the distal tip includes less than 20%, less than 10% or less than 5% of the distal most length of the securement arm 201. In at least one example, the electronic port 218 is disposed at or with the distal tip 217 of the securement arm 201.

As shown in FIG. 2A the waveguide 210, battery 216, and the electronic port 218 can be connected via an electrical circuit 222. In some embodiments, the electrical circuit 222 can be configured to connect components throughout the device 100. The electrical circuit 222 can connect components through the proximal end 208 and the distal end 214, along with the first joint 206 and second joint 212 of the securement arm 201. The electric circuit 222 can also be configured to connect components disposed in the viewing frame 202 of the device 100. For example, electrical charge input to the device 100 via the electronic port 218 can be fed to the battery 216. The charge stored in the battery 216 can then be connected to power the electronic components 210.

As shown in FIG. 2B, the device is configured to be donned by a user. When worn on a user's head 220, the device 100 can be placed in any number of ways, one of which being where the securement arm 201 can rest on top of the user's ear 224. In this position, the distal end 214 of the securement arm can be set to rest above the user's ear 224.

In at least some examples, the distal end 214 above the user's ear 224 can cause the distal tip 217 to be disposed behind the user's ear 224. The distal tip 217 of the securement arm 201. In one example, the distal tip 217 includes 30% or less of a total length of the securement arm 201 at the distal end thereof such that the distal tip 217 is disposed behind the user's ear when donned. In some examples, the distal tip includes less than 20%, less than 10%, or less than 5% of the distal most length of the securement arm 201. The electronic port 218 can be disposed at the distal tip 217 of the securement arm 201. The distal tip 217 is an easily accessible area of the securement arm 201 disposed behind the user's ear where the user can connect external attachments without disrupting other functions of the device 100, including securement functions of the securement arms 201 and display functions of the viewing frame 202. Adding external attachments behind the user's ear 224 can keep the user's field of view free where it could otherwise have a negative impact on the user's experience. The distal position of the electronic port 218 at the distal tip 217 of the securement arm 201 can also provide easy access for connecting exterior attachments to the device 100 without interfering with the user or the overall functionality.

Any of the features, components, and/or parts, of the rim 360 including the arrangements and configurations thereof shown in FIGS. 2A and 2B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A and 2B.

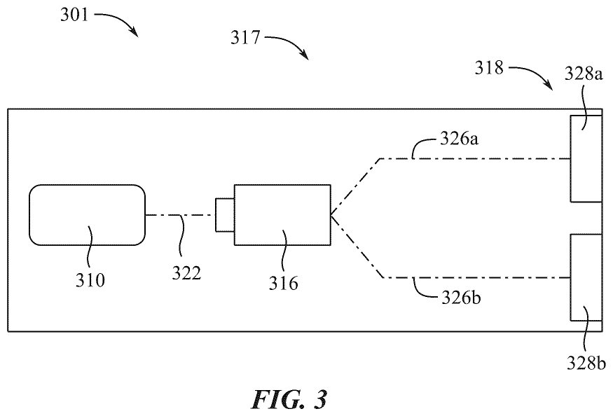

FIG. 3 shows a side-view of an example of a securement arm 301. In at least one example, the securement arm 301 can house any number of components. These components can include, but are not limited to, a projector 310, a waveguide, a battery 316, and an electronic port 318. The various components can be connected via an electrical circuit 322. In some examples, the electronic port 318 can include a system of at least a first and second electrical contact 328a and 328b. The first and second electrical contacts 328a and 328b can be externally exposed and can be accessed from outside the securement arm 301. In at least one example, the at least first and second electrical contacts 328a and 328b can be connected to the electric circuit 322 by the use of contact circuits 326a and 326b. In at least one example, the battery 316 can electrically couple the contact circuits 326a and 326b to the waveguide 310. In some embodiments, the battery 316 can be disposed in the distal tip 317.

In at least one example, the electronic port 318 can be used to perform different types of functions. In some examples, the electronic port 318 can include a power port. The power port can enable charging of the device of which the securement arm 301 is a part. In at least one example, the port 318 can also include a data entry port. The data entry port can enable the device to receive instructions, updates, and like information from an exterior source. In examples where the port 318 includes a data entry port, the electrical contacts 328a-b can be electrically coupled with one or more processors, memory components, or other components connected via the circuits 326a-b.

Any of the features, components, and/or parts, of the rim 360 including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

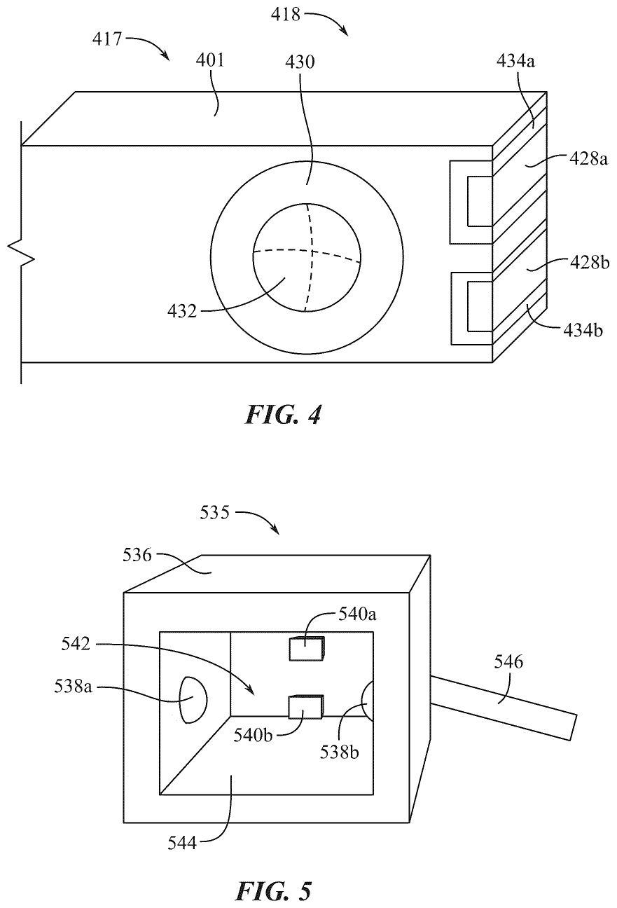

FIG. 4 shows a perspective view of a slip-over port 418. The slip-over port 418 can be located at the distal tip 417 of the securement arm 401. The slip-over port 418 can include various configurations to accept a variety of different external attachments. In at least one example, the slip-over port 418 can include a retention feature, for example a retention indent 432. The retention indent 432 can recede into the body of the securement arm 401 to accept a variety of different external retention devices with complimentary features configured to mate with the retention indents 432 and mechanically lock attachments thereto via friction fits. In other examples, the retention features can be convex protrusions 432 extending away from the arm 301 to accommodate complimentary indents of external attachments. The retention indent 432 can be surrounded by a retention material 430. This retention material 430 can consist of the same material as the securement arm 401 or can differ from the base material of the securement arm 401 to maximize attachment retention or case of access for different external devices.

In at least one example, the slip-over port 418 can include at least first and second electrical contacts 428a and 428b. The electrical contacts 428a and 428b can be disposed on the external surface of the securement arm 401. In one example, this configuration can allow the electrical contacts 428a and 428b to be easily accessible to a variety of different external devices. In at least one example, the electrical contacts 428a and 428b can be surrounded by insulators 434a and 434b. The insulators 434a and 434b can contain the charge received by the electrical contacts 428a and 428b. This can be advantageous to the device in that the electrical charge from electrical contacts 428a and 428b can be prevented from being distributed across the securement arm 401, regardless of the base material used.

Any of the features, components, and/or parts, of the rim 360 including the arrangements and configurations thereof shown in FIG. 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

FIG. 5 illustrates a perspective view of an example of a slip-over external attachment 535 configured to electrically couple to the slip-over port 418 shown in FIG. 4. In one example, the slip-over external attachment 535 can include an outer casing 536. The outer casing 536 can define a case aperture 542. The case aperture 542 can be various sizes in various examples to correspond to the size of the distal tip 417 of the arm 401 shown in FIG. 4. In one example, an inner aperture surface 544 can include of the same material as the outer casing 536 or a different material in other examples. In at least one example, the case aperture 542 can define a width and height that is greater than the width and height of the slip-over port 418. This configuration can be advantageous to the device 100 in that the slip-over external attachment 535 can be attached to the slip-over port 418 by securing it over the distal tip of the securement arm 401.

In at least one example, the case aperture 542 of the slip-over external attachment 500 can include at least a first and second ball detent 538a and 538b. The first and second ball detents 538a and 538b can protrude from the case aperture 542. This can allow the ball detents 538a and 538b to lock into the retention indent 432 of the slip-over port 418 when slipped over the distal tip 417 of the securement arm 401, thus creating a means of retention. As noted above, in examples where the retention features shown in FIG. 4 are protrusions rather than detents, the ball detents 538a-b of the slip-over external attachment 535 can include recessed indentations corresponding to the protrusions of the slip-over port 418. This retention system can be advantageous to the user in that the device 100 can be attached to the slip-over external attachment 535 while the user is operating the device 100, thus enabling the user to move dynamically without losing the physical and electrical connections between the device 100 and the slip-over external attachment 535.

In one example, the slip-over external attachment 535 can be configured with external electrical contacts 540a and 540b. The external electrical contacts 540a and 540b can protrude into the case aperture 542. This can allow the external electrical contacts 540a and 540b to be easily accessible to the electrical contacts 428a and 428b when the slip-over external attachment 535 is connected to the slip-over port 418. Furthermore, in at least one example the external electrical contacts 540a and 540b can be electrically connected to an electric cord 546, where the electric cord 546 can be a data cord, a power cord, or a combination of both a data and power cord. In one example, when the slip-over external attachment 535 is secured to the slip-over port 418, the electrical contacts 540a-b can contact and electrically couple with the electrical contacts 428a-b of the slip-over port 418. This contact can enable electrical power or data to be transferred from the cord 546 to the various components of the head-mountable device via one or more circuitry components thereof, as described above with reference to one or more other examples.

Any of the features, components, and/or parts, of the rim 360 including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

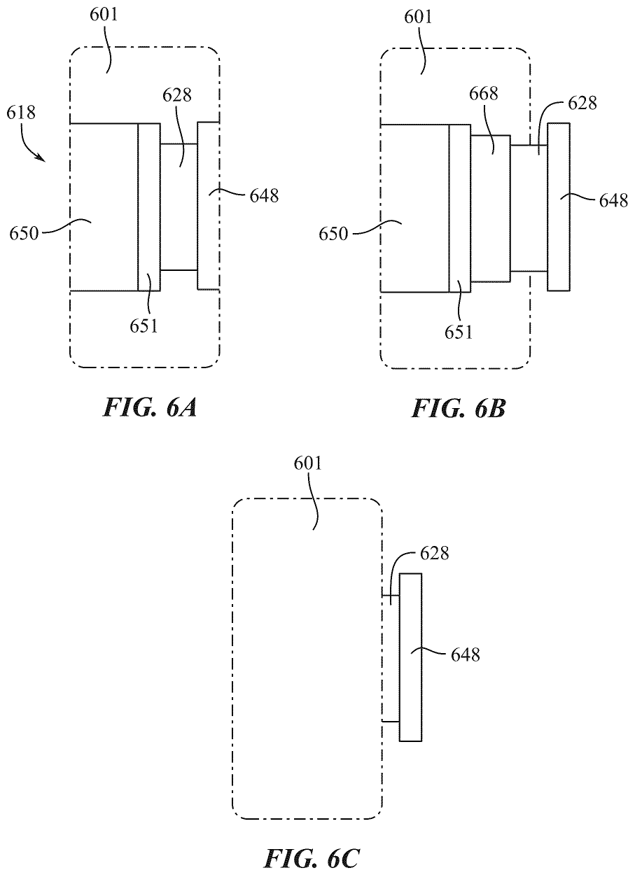

FIG. 6A illustrates a cross-sectional side-view of a selectively translatable electronic port 618 in a closed position. This selective port 618 can be configured in at least one of two ways; either through a magnetic method or a mechanical method. The magnetic method of operating the selective port 618 can be configured with a pin baseplate 650 that can be housed within the distal tip of the securement arm 601. In one example, the pin baseplate 650 can contain an attraction plate 651. The attraction plate 651 can be a magnetic component that draws leakage flux from the electric circuits contained in the device 100. For example, the leakage current from the electric circuit 322 can be used by the attraction plate 651 to induce a magnetic force that can be utilized as a retention system for the selective port 618.

In some examples, an electrical contact 628 can be radially connected to the pin baseplate 650. In some examples, a pin outer cover 648 can be radially attached to the electrical contact 628. This pin outer cover 648 can have a diameter larger than the diameter of the electrical contact 628. A larger diameter on the pin outer cover 648 can help enclose and seal off the electrical contact 628 when the selective port 618 is in the closed position. In one example, in the closed position, the pin outer cover can be flush with the surface of the securement arm 601 and can seal the electrical contact 628 from external contact, thus making it inaccessible to moisture, snagging, or other unwanted contact. The difference in diameters between the pin outer cover 648 and the electrical contact 628 can also provide a means of retention to possible external attachments, for example, the external attachment can clip on to the pin outer cover and gain access to the electrical contact 628.

FIG. 6B shows a cross-sectional side-view of a selective port 618 in an open position. The open position, shown in FIG. 6B, as opposed to the closed position, shown in FIG. 6A, can allow the pin outer cover to protrude past the surface of the securement arm 601. This extension can also push the electrical contact 628 past the surface of the securement arm 601, making it accessible to external attachments.

In at least one example, a pin interior extension 668 can be configured to extend the electrical contact 628 and the pin outer cover 648 past the surface of the securement arm 601. In the closed position, the pin interior extension 668 can be housed inside the pin baseplate 650. In some examples, the electrical contact 628 can be constructed out of a magnetic material or contain a magnet. In the closed position, the attraction plate 651 can exert a magnetic force on the electrical contact 628 to hold the selective port 618 in a closed position, wherein the pin interior extension can be retained within the pin baseplate 650. This magnetic force can hold the selective port 618 in the closed position until it is acted upon by a stronger external magnetic force, which can bring the selective port 618 into the open position.

FIG. 6C shows an external side-view of the selective port 618 in the open position. In at least one example, the electrical contact 628 and the pin outer cover 648 can protrude from the surface of the securement arm 601. The closed position of the selective port 618 can allow the pin outer cover 648 to lie flush with the surface of the securement arm 601. This magnetic force exerted from the attraction plate 651 and the resulting retention features can be advantageous to the user of the device 100 in that the user can perform a variety of movements without the selective port 618 unintentionally moving from a closed position to an open position. This retention can further prevent unwanted materials from entering the selective port 618 or external items snagging on the device 100.

Any of the features, components, and/or parts, of the rim 360 including the arrangements and configurations thereof shown in FIGS. 6A through 6C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 6A through 6C.

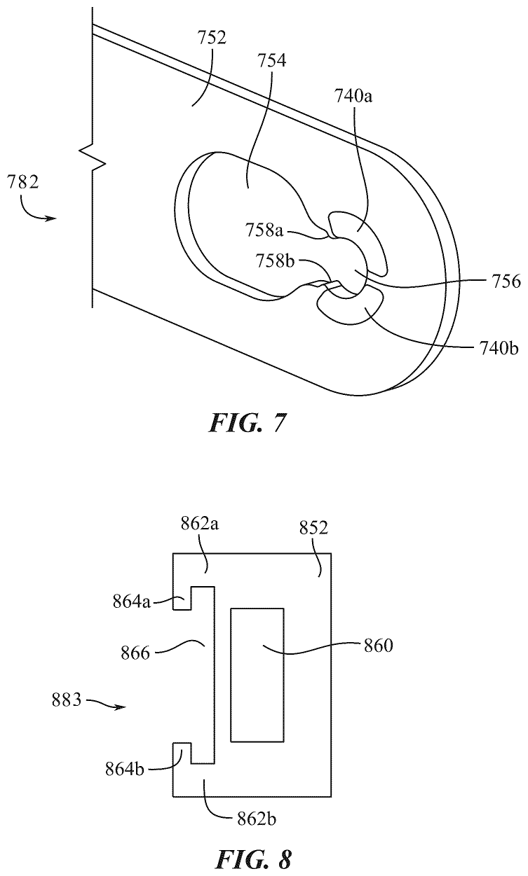

FIG. 7 shows a perspective view of an example of an attachment clip 782 for use with the port 618 shown in FIGS. 6A-6C. In one example, the attachment clip 782 can be used to clip an external device to the device 100 through use of a selective port 618. In one example, the attachment clip 782 can include an exterior clip arm 752, with the tip of the exterior clip arm 752 defined by a pin entry aperture 754. In at least one example, the pin entry aperture 754 can be configured to have a diameter and/or an area larger than the pin outer cover 648 defined in FIG. 6A. A retention funnel can be attached adjacent to the pin entry aperture 754 and the end of the retention funnel can be defined by locking ridges 758a and 758b.

FIG. 7 further illustrates, in at least one example, a pin inner aperture 756 than can be defined by a diameter less than the pin entry aperture 754 but greater than the locking ridges 758a and 758b. The pin inner aperture 756 can be configured to have a diameter smaller than the pin outer cover 648 but equal to or greater than the diameter of the electrical contact 628 as shown in FIG. 6A. In at least one example, one or more electrical contacts, including first and second electrical contacts 740a and 740b, can at least partially define the pin inner aperture 756.

In this way, the attachment clip 782 can be inserted around the open selective port 618 and the electrical contact 628 thereof can be secured within the pin inner aperture 756 so the electrical contact 628 contact the electrical contacts 740a-b thereof with the locking ridges 758a-b aiding in retention of the selective port 168. In this way, the selective port 618 can receive electrical power and/or data from the attachment clip 782 when secured together.

Any of the features, components, and/or parts, of the rim 360 including the arrangements and configurations thereof shown in FIG. 7 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 7.

FIG. 8 shows a side-view of an example of a magnetic attachment 883. In at least one example, the magnetic attachment 883 can include a magnetic clip arm 852, which can be configured to house a magnet 860. The exterior magnetic clip arm 852 can protrude along an edge to create top and bottom extension walls 862a and 862b. Furthermore, in at least one example, top and bottom retention flanges 864a and 864b can extend from both the top and bottom extension walls 862a and 862b, respectively. The combination of the magnetic clip arm 852, top and bottom extension walls 862a-b, and top and bottom retention flanges 864a-b can be configured to define a pin retention aperture 866. The pin retention aperture 866 can be configured to receive the pin outer cover 648 to attach an exterior device to the securement arm 601 of the device 100.

Any of the features, components, and/or parts, of the rim 360 including the arrangements and configurations thereof shown in FIG. 8 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 8.

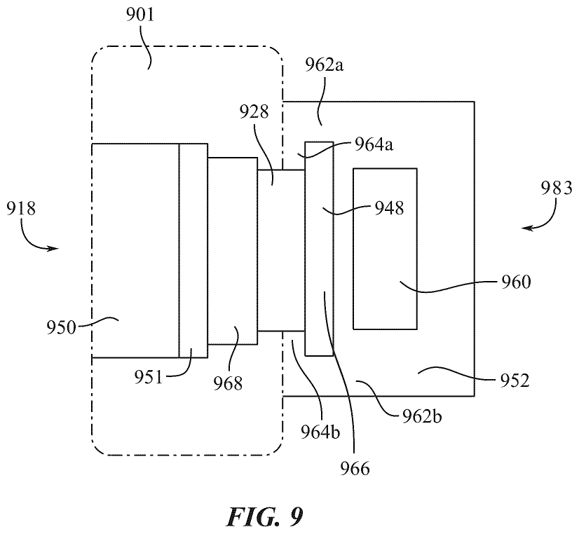

FIG. 9 shows an example of the joining of a selective port 918 and a magnetic attachment 982, which can be similar or the same as examples of the selective port 618 and the magnetic attachment 883 shown in FIGS. 6A-6C and 8, respectively. In at least one example, the magnetic clip arm 952 can be moved over the selective port 918 so as to change the selective port 918 from a closed position to an open position, as illustrated in FIGS. 6A and 6B. The positioning of the magnet 960 in close proximity to the selective port 918 can cause the electrical contact 928 to be put in reach of the magnetic forces exerted by the magnet 960, wherein in the magnetic forces exerted by the magnet 960 can be greater than the magnetic forces exerted by the attraction plate 951. Moving the magnetic attachment closer to the selective port 918 can cause the electrical contact 928 to move closer towards the magnet 960, which in turn can cause the selective port 918 to move into an open position. The open position can be defined as the pin interior extension 968 extending out of the pin baseplate 950, which can allow the electrical contact 928 to be exposed past the surface of the securement arm 901.

In at least one example, the pin retention aperture 966 can be configured to receive the pin outer cover 948 of the selective port 918 in an open position. When the pin outer cover 948 is received, the top and bottom extension walls 962a and 962b, in combination with the top and bottom retention flanges 964a and 964b, can wrap around the pin outer cover 948 to retain the pin outer cover 948 within the pin retention aperture 966. This system of retention can be advantageous to the user of the device 100 in that the user can perform various movements without the selective port 918 losing connection with the magnetic attachment 983.

In some examples, the electrical contact 928 or the pin outer cover 948, or both, can be rotatable. This can be advantageous for the user of the device 100 in that the magnetic attachment 983 can be rotated in relation to the securement arm 901 while still holding physical retention and an electrical connection.

Any of the features, components, and/or parts, of the rim 360 including the arrangements and configurations thereof shown in FIG. 9 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 9.

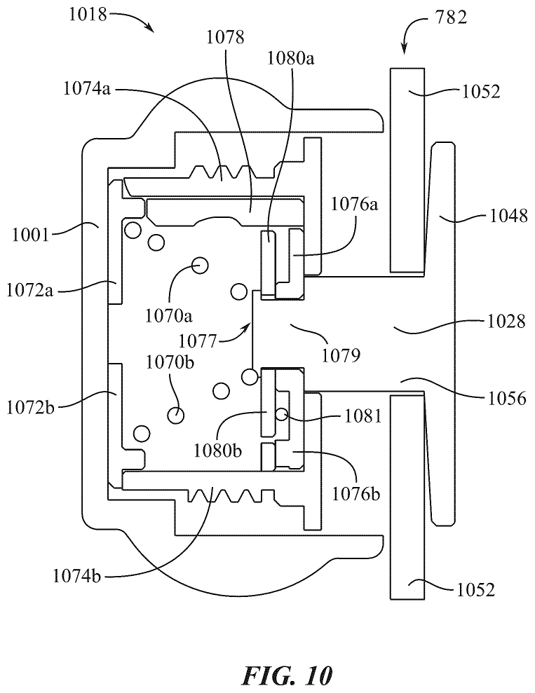

FIG. 10 shows a side view of a selective port 1018 joined to an attachment clip 1082, wherein the translatable electronic port 1018 can be manually operable between the closed and open configurations illustrated by FIGS. 6A and 6B. Referring to FIG. 10, in at least one example, the attachment clip 1082 can include a clip arm 1052, wherein the clip arm 1052 can be defined by a pin inner aperture 1056. The pin inner aperture 1056 can be configured to receive the pin outer cover 1048 and electrical contact 1028 of the selective port 1018. In one example, the clip arm 1052 can wrap around a portion of the circumference of the electrical contact 1028.

In at least one example, the selective port 1018 can be manually operable between the open and closed configurations illustrated in FIGS. 6A and 6B. According to the present disclosure, opening and closing can be done through the use of compressing springs 1070a and 1070b to extend and retract the electrical contact 1028. In one example, the user can manually manipulate the selective port 1018 into open and closed positions by pressing on top and bottom spring plates 1072a and 1072b. In one embodiment, top and bottom spring plates 1072a and 1072b can be attached to springs 1070a and 1070b, which can allow them to compress based on action from the user. The springs 1070a and 1070b can also attach to top and bottom spring forward plates 1080a and 1080b, wherein the spring forward plates 1080a and 1080b can push on a pin inner cover 1077, which can be an axial extension from the electrical contact 1028.

In one example, the top and bottom forward spring plates 1080a and 1080b can also press against top and bottom retention catches 1076a and 1076b, respectively. The spring plates 1080a, 1080b, and the retention catches 1076a and 1076b can be configured to fill the space defined between the pin inner cover 1077, the pin inner diameter 1079, and the electrical contact 1028. This can provide a means by which the electrical contact 1028 can be moved inside and outside of the securement arm 1001. Furthermore, the retention catch can house a retention spring 1081, which can be configured to

In one example, top and bottom pin guides 1074a and 1074b can also be housed inside the securement arm 1001. The pin guides 1074a, 1074b can act as a form of retention so the other components housed inside of the securement arm 1001 can move as designed. A guide buffer 1078 can be placed inside the selective port 1018 between the top pin guide 1074a and the top spring plate 1072a which can enable the pin guides 1074a and 1074b to move with the spring plates 1072a and 1072b when the user actuates the selective port 1018 from a closed to open position, or vice versa.

Any of the features, components, and/or parts, of the rim 360 including the arrangements and configurations thereof shown in FIG. 10 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 10.

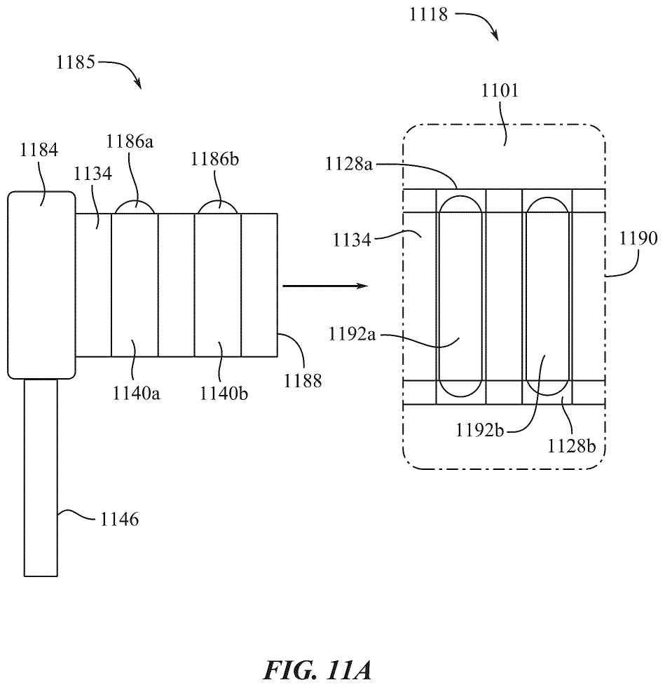

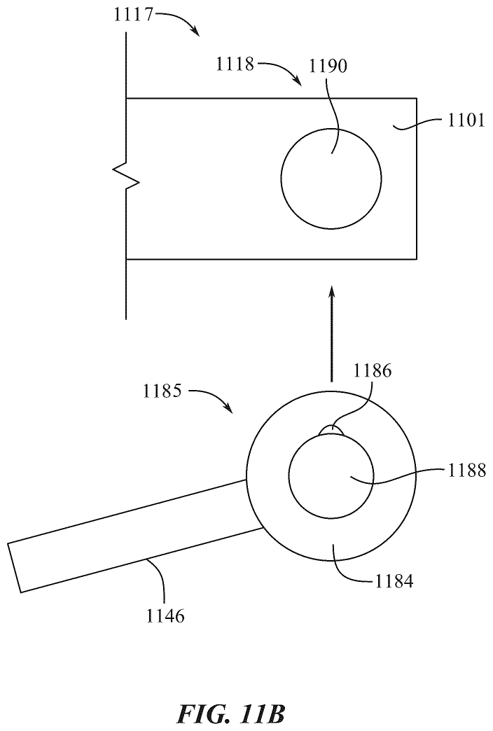

FIG. 11A illustrates a cross-sectional side-view of an axial port 1118 and a side view of an axial attachment 1185. In at least one example, the axial electrical port 1118 can be constructed at the distal tip 1117 of the securement arm 1101, where the axial port 1118 can be defined by an axial aperture 1190. In at least one example, the axial aperture 1190 can define a through-hole extending entirely through the distal tip of the securement arm 1101. Furthermore, in some embodiments the axial port 1118 can be configured to receive the axial attachment 1185 through the axial aperture 1190.

In various examples, the axial electrical port 1118 can include a variety of different components for the retention and connection of an axial attachment 1185. In some examples, the axial aperture 1190 can further be defined by first and second axial electrical contacts 1128a and 1128b. In some examples, the first and second axial electrical contacts 1128a and 1128b can be configured to extend partly or entirely around the circumference of the axial aperture 1190. In at least one example, ball indents 1192a and 1192b can be cut into the first and second axial electrical contacts 1128a and 1128b, where the ball indents 1192a and 1192b can also extend partly or entirely around the circumference of the axial aperture 1190.

In some examples, insulator material 1134 can be disposed between and around the electrical contacts 1128a and 1128b. The insulator material 1134 can be advantageous to the device 100 in that it can keep the charge applied to electrical contacts 1128a and 1128b from being dispersed to other parts of the device 100.

The axial attachment 1185 can include an axial base 1184, where, in at least one example, an electrical cord 1146 can be attached. In some examples, the electrical cord 1146 can be a power cord, a data cord, or a combination of both a power and data cord. An axial insert 1188 can extend from the axial base 1184, wherein the axial insert can include any number of components for electrical connection and physical retention to the axial port 1118.

In at least one example, the axial insert 1188 can include first and second exterior electrical contacts 1140a and 1140b. In some examples, the first and second exterior electrical contacts 1140a and 1140b can extend partly or entirely around the circumference of the axial insert 1188. Insulator material 1134 can also be placed between and around the first and second exterior electrical contacts 1140a and 1140b. The insulator material 1134 can be advantageous to the device 100 in that it can keep the charge applied to electrical contacts 1128a and 1128b from being dispersed to the other parts of the axial attachment 1185 or the device 100.

In some examples, the axial port 1118 can be configured to receive the axial attachment 1185. Ball indents 1192a and 1192b can be configured to receive ball detents 1186a and 1186b when the axial attachment 1185 is inserted into the axial port 1118 through the axial aperture 1190. When inserted, the exterior electrical contacts 1140a and 1140b can line up with the axial electrical contacts 1128a and 1128b, wherein the ball detents 1186a and 1186b can lock into the ball indents 1192a and 1192b, respectively. As noted above with reference to other examples, the ball indents 1192a-b and ball detents 1186a-b can be switched such that the axial port 1118 includes ball detents and the axial attachment includes corresponding ball indents.

When the axial attachment 1185 is inserted into the axial port 1118, the axial insert 1188 can be configured to lie flush with the surface of the securement arm 1101. This can be advantageous to the user of the device 100 in that it can prevent unwanted materials from entering into the axial aperture 1190. In some examples, the seal created between the axial insert 1188 and the securement arm 1101 can prevent moisture, such as sweat from the user, from entering the axial aperture 1190, thus keeping clear the connection between the exterior electrical contacts 1140a and 1140b and the axial electrical contacts 1128a and 1128b.

The retention system created between ball detents 1186a, 1186b and ball indents 1192a, 1192b, can be advantageous to the user of the device 100 in that the user can perform various movements without the axial attachment 1185 losing connection from the axial port 1118. Forces exerted from various directions can be mitigated with the use of the retention system described herein. Furthermore, the axial design of the physical connection between the ball detents 1186a and 1186b and the ball indents 1192a and 1192b can be advantageous to the user in that the axial attachment can be rotated without losing connection between the axial attachment 1185 and the axial port 1118. For example, FIG. 11B shows a side-view of the axial port 1118 and a top-view of the axial attachment 1185. In this example, when the axial insert 1188 is placed into the axial aperture 1190, the axial attachment 1185 can rotate around the circumference of the axial aperture 1190, which can allow the cord 1146 to be oriented in a direction most desirable by the user.

Any of the features, components, and/or parts, of the rim 360 including the arrangements and configurations thereof shown in FIGS. 11A and 11B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 11A and 11B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A device, comprising:
a frame;
a window secured to the frame;
a securement arm including:
a proximal end secured to the frame; and
a distal tip opposite the proximal end;
a waveguide disposed in the securement arm and configured to direct light displayed at the window; and
an electronic port disposed at the distal tip and electrically coupled to the waveguide.

2. The device of claim 1, wherein the distal tip is configured to be disposed behind a user's ear when the user dons the device.

3. The device of claim 1, wherein:
the securement arm includes:
a first joint between the proximal end and the frame; and
a second joint between the proximal end and the distal tip.

4. The device of claim 3, wherein:
the port is disposed distal to the second joint; and
the waveguide is disposed between the first joint and the second joint.

5. The device of claim 1, wherein the port comprises an aperture defined by the distal tip.

6. The device of claim 5, wherein:
the distal tip includes an inner surface defining the aperture; and
a first electrical contact and a second electrical contact define the inner surface.

7. The device of claim 6, further comprising a battery disposed in the distal tip and electrically connecting the first electrical contact and the second electrical contact to the waveguide.

8. The device of claim 1, wherein the electronic port comprises:
a first electrical contact defining a first portion of an external surface of the securement arm; and
a second electrical contact defining a second portion of the external surface.

9. An electronic securement arm for a wearable device, comprising:
a housing including:
a proximal portion; and
a distal portion disposed at an angle relative to the proximal portion;
a battery disposed in the housing; and
a port disposed in the distal portion, the port comprising:
an aperture defined by the distal portion;
a contact electrically coupled to the battery and disposed in the aperture; and
a retention feature defined by the distal portion.

10. The electronic securement arm of claim 9, wherein the aperture defined by the distal portion comprises a through-hole extending entirely through the distal portion.

11. The electronic securement arm of claim 9, wherein the port comprises a data entry port.

12. The electronic securement arm of claim 11, wherein the port comprises a power port.

13. The electronic securement arm of claim 11, wherein:
the distal portion includes an inner surface defining the aperture;
the inner surface further defines a detent; and
the retention feature comprises the detent.

14. The electronic securement arm of claim 13, wherein:
a first electrical contact defines the inner surface; and
a second electrical contact defines the inner surface.

15. A smart glasses arm, comprising:
a distal tip;
an electronic component disposed in the distal tip;
an electronic port disposed at the distal tip, the electronic port comprising:
a selectively translatable electrical contact;
an open configuration including the electrical contact exposed to an external environment; and
a closed configuration including the electrical contact disposed within the distal tip.

16. The smart glasses arm of claim 15, wherein:
the electronic port comprises:
a first portion having a first diameter; and
a second portion having a second diameter less than the first diameter;
the first portion defines an external surface of the distal tip in the closed configuration; and
the second portion includes the electrical contact.

17. The smart glasses arm of claim 15, wherein the electronic port is configured to be manually operable between the open configuration and the closed configuration.

18. The smart glasses arm of claim 15, wherein the electronic port comprises a magnet.

19. The smart glasses arm of claim 18, wherein the electronic port is magnetically operable between the open configuration and the closed configuration.

20. The smart glasses arm of claim 19, further comprising:
a ferrous component disposed in the distal tip; and
wherein the magnet attracts the ferrous component when the electronic port is in the closed configuration.
